(19) United States
(12) Patent Application Publication
(10) Pub. No.: US 2006/0036017 A1
(43) Pub. Date: Feb. 16, 2006

(54) Rubber composition comprising modified filler

(76) Inventors: Adam Gronowski, Sarnia (CA); Rui Resendes, Corunna (CA); Philip Brain, Sarnia (CA)

Correspondence Address: LANXESS CORPORATION, 111 RIDC PARK WEST DRIVE, PITTSBURGH, PA, 15275-1112, US

(21) Appl. No.: 10/993,638

(22) Filed: Nov. 19, 2004

(30) Foreign Application Priority Data
Aug. 11, 2004 (CA) 2,487,906

(51) Int. Cl. C08K 3/04

(52) U.S. Cl. 524/495

(57) ABSTRACT

The present invention is directed to peroxide curable rubber compositions, processes for their preparation, and modified fillers therefor. The compositions contain one or more polymers having repeating units derived from one or more isoolefin monomers (e.g. isobutene) and repeating units derived from one or more multiolefin monomers (e.g. isoprene). The compositions also contain modified fillers comprising a particulate composite of a particulate filler (e.g. carbon black) and a multiolefin crosslinking agent (e.g. divinylbenzene). Such rubber compositions find application particularly in condenser caps, biomedical devices, pharmaceutical devices (e.g. stoppers in medicine-containing vials, plungers in syringes, etc.), and seals for fuel cells.

### FIELD OF THE INVENTION

The present invention relates to modified fillers and rubber compositions comprising such modified fillers. In particular, the present invention relates to peroxide curable rubber compositions comprising one or more polymers and a modified filler. The modified filler comprises a particulate composite of a particulate filler and a multiolefin crosslinking agent.

### DESCRIPTION OF RELATED ART

Rubber products, including tires, are typically prepared utilizing elastomer-based rubber compositions that are reinforced with a particulate filler like carbon black or sometimes silica. A general description of carbon blacks can be found, for example, in “The Vanderbilt Rubber Handbook” (1990), pages 416-418. Representative examples of such carbon blacks are N110, N121, N234, N330, N660 and the like.

In many of its applications, isoolefin copolymers, in particular butyl rubber is used in the form of cured compounds. Such compounds usually contain, besides the rubber, a filler, curative(s), process oil, plasticizer(s), processability-improving polymers, antioxidants, etc. Typically, various ingredients are added sequentially to a mixer to form a uniform composition (a blend) before the onset of a vulcanization process.

There are inherent processing difficulties relating to mixing a liquid additive with rubber together with other compounding ingredients in a rubber mixer. In several cases it has been found that the use of a pre-formed composite of a filler and a given compounding ingredient is beneficial. For example, it is a common practice to use a coupling agent in conjunction with the silica to couple the silica to the elastomer(s) of the rubber composition. For liquid coupling agents, a carrier for the coupling agent, such as carbon black, might be used to introduce it into the rubber composition where the coupling agent and the silica are subsequently combined in-situ in the rubber composition. In such a case, the liquid coupler is pre-deposited on the carbon black prior to mixing it with the mixture of rubber and other ingredients (e.g. U.S. Pat. No. 6,053,226).

Bergemann et al. (U.S. Pat. No. 6,660,075) describes a method of producing modified carbon blacks having organic groups. In this process the black was reacted with organic compounds containing a carbon-carbon double or triple bond activated by at least one substituent.

A pre-formed ‘composite’ of a liquid melamine derivative and carbon black gave a free flowing particulate for easy blending with a rubber composition (EP 1,362,888). This composite was considered different from a simple, aggregate mixture of both ingredients.

Butyl rubber (a copolymer of isobutylene and a small amount of isoprene) is known for its excellent insulating and gas barrier properties. In many of its applications butyl rubber is used in the form of cured compounds. Vulcanizing systems usually utilized for this polymer include sulfur, quinoids, resins, sulfur donors and low-sulfur high performance vulcanization accelerators.

Peroxide curable rubber compounds offer several advantages over conventional, sulfur-curing systems. Typically, these compounds display very fast cure rates and the resulting cured articles tend to possess excellent heat resistance and low compression set. In addition, peroxide-curable formulations are much “cleaner” in that they do not contain any extractable inorganic impurities (e.g. sulfur). Such rubber articles can therefore be used, for example, in condenser caps, biomedical devices, pharmaceutical devices (stoppers in medicine-containing vials, plungers in syringes) and possibly in seals for fuel cells. The use of butyl-type rubber is especially preferred for sealing applications because of its non-permeability of gases such as oxygen, nitrogen, etc., and moisture and its stability to acids, alkalis and chemicals.

Co-pending Canadian patent application 2,458,741, the disclosure of which is herein incorporated by reference, describes the preparation of butyl-based, peroxide curable compounds utilizing novel grades of high isoprene (ca. 5.5-7.5 mol %) butyl rubber. N,N′-m-phenylenedimaleimide is used as a cure promoter (co-agent). Such butyl rubber with a higher than conventional content of isoprene (>2.2 mol %) should be beneficial for applications where free radicals are involved for vulcanization. It was pointed out (Rubber Chem. Technol. 42, (1969) 1147-1154) that isoprene units contribute to crosslinking reactions of butyl rubber with peroxides and at the isoprene level in the rubber ca. 3 mol % the crosslinking and scission reactions balance out.

A commercially available terpolymer based on isobutylene, isoprene and divinylbenzene (DVB) (Bayer XL-10000, e.g. Canadian patent 817,939) is curable with peroxides alone. However, this material possesses some disadvantages. Since the DVB is incorporated during the polymerization process, a significant amount of crosslinking occurs during manufacturing. The resulting high Mooney viscosity (ca. 60-75 MU, ML1+8@125° C.) and presence of gel particles make this material very difficult to process. Certain modifications in the processing equipment during manufacturing are required for this specific rubber grade which involve additional costs. It would be desirable to have an isobutylene-based polymer which is peroxide curable and completely soluble (i.e. gel free).

One of the applications of XL-10000 cured with peroxides is for aluminum electrolytic condenser caps. A material for a condenser cap should have both a high hardness (Shore A>70 units) and a good elongation (≧200%). It is not easy with XL-10000 to satisfy simultaneously these two requirements. Usually, a more soluble XL-10000 gives compounds with a low hardness and a highly insoluble rubber gives compounds with a low elongation. XL-10000 is manufactured so that the solubility limits are controlled (within. 20-30 wt % solubility range) and the ‘window’ for good performance is quite narrow.

It is well known that butyl rubber and polyisobutylene decompose under the action of organic peroxides. Furthermore, U.S. Pat. No. 3,862,265 and U.S. Pat. No. 4,749,505 teach us that copolymers of a C4 to C7 isomonolefin and up to 10 wt % isoprene or up to 20 wt % para-alkyl styrene undergo molecular weight decrease when subjected to high shear mixing. The effect is enhanced in the presence of free radical initiators.

Mori et al. (JP 06-172547/1994) describe a process for crosslinking butyl rubber in the presence of an organic peroxide and a polyfunctional monomer containing an electron-withdrawing group (e.g. ethylene dimethacrylate, trimethyloipropane triacrylate, N,N′-m-phenylene dimaleimide). The product has carbon-carbon bonds at the crosslinking points and therefore considerably improved heat resistance compared to butyl rubbers conventionally cured with sulfur.

Kawasaki et al. (JP 06-107738/1994) describe a partially crosslinked butyl rubber composition capable of providing a cured product having excellent physical properties, heat resistance and low compression set. This is achieved by adding a vinyl aromatic compound (e.g. styrene, divinylbenzene) and organic peroxide to regular butyl rubber and partially crosslinking the butyl rubber while applying mechanical shearing force to this blend system. First the rubber and liquid divinylbenzene were mixed together in a kneader and then peroxide and other ingredients were added under more shear. In their examples, either sulfur, a quinone dioxime or alkylphenol resin (well known vulcanizing agents for butyl rubber) is present in the formulation, besides peroxide and DVB. No case is given where the compound containing butyl rubber and DVB is cured with peroxides alone.

### SUMMARY OF THE INVENTION

According to an aspect of the invention, there is provided a peroxide curable rubber composition comprising: one or more polymers having repeating units derived from one or more isoolefin monomers and repeating units derived from one or more multiolefin monomers; and, a modified filler comprising a particulate composite of a particulate filler and a multiolefin crosslinking agent.

According to another aspect of the invention, there is provided a process for preparing a cured rubber composition comprising: mixing a polymer having repeating units derived from one or more isoolefin monomers and repeating units derived from one or more multiolefin monomers with a modified filler comprising a particulate composite of a particulate filler and a multiolefin crosslinking agent to form a mixture; and, curing the mixture with one or more peroxides.

According to yet another aspect of the invention, there is provided a modified filler comprising a particulate composite of a particulate filler and a multiolefin crosslinking agent.

According to still yet another aspect of the invention, there is provided a shaped article comprising a rubber composition of the present invention.

Further features of the invention will be described or will become apparent in the course of the following detailed description.

### DETAILED DESCRIPTION OF PREFERRED EMBODIMENTS

Modified Filler:

The modified filler comprises a particulate composite of a particulate filler and a multiolefin crosslinking agent. The composite is pre-formed to form a free-flowing particulate before it is mixed with polymer. Free flowing particulate composites are much easier to handle in compounding operations than are liquid multiolefin crosslinking agents. Use of such modified fillers in rubber compositions permits peroxide curing of the rubber and surprisingly leads to improved physical characteristics of the cured rubber compositions, for example MDR and stress-strain characteristics.

The particulate filler may be any filler that can form a composite with the multiolefin crosslinking agent without destroying the crosslinking ability of the multiolefin crosslinking agent. Some representative examples of suitable particulate fillers are various types of carbon black and silica. Carbon black is preferred. Carbon blacks are more preferred. Carbon black has a surprisingly good capability for forming particulate composites with multiolefin crosslinking agents even at a high loading of the multiolefin crosslinking agent.

Special carbon blacks are not required. A general description of useful carbon blacks can be found, for example, in “The Vanderbilt Rubber Handbook” (1990), pages 416-418. The carbon black may be, for example, furnace black, gas black, channel black, flame black, thermal black, acetylene black, plasma black, inversion blacks, etc. The carbon black may be reinforcing, semi-reinforcing, non-reinforcing, etc. Representative examples of carbon blacks are N110, N121, N234, N330, N660, N762 and the like.

A special particle size of the particulate filler is not required. Preferably, the average particle size is in a range of from 8 nm to 350 nm, more preferably from 8 nm to 100 nm. Particulate filler with smaller average particle size, hence larger surface area for a given mass, may possess a higher capacity for forming composites with the multiolefin crosslinking agent. Particulate filler having smaller particle size may also lead to improved physical properties of the final rubber composition, for example, tensile strength, hardness and abrasion resistance.

The choice of multiolefin crosslinking agent is not particularly restricted. Preferably, the multiolefin crosslinking agent contains no transition metal compounds and no organic nitro compounds. Preferably, the multiolefin crosslinking agent comprises a multiolefinic hydrocarbon compound. Examples of these are norbornadiene, 2-isopropenylnorbornene, 2-vinyl-norbornene, 1,3,5-hexatriene, 2-phenyl-1,3-butadiene, divinylbenzene, diisopropenylbenzene, divinyltoluene, divinylxylene and C₁ to C₂₀ alkyl-substituted derivatives thereof. More preferably, the multiolefin crosslinking agent is divinylbenzene, diisopropenylbenzene, divinyltoluene, divinyl-xylene and C₁ to C₂₀ alkyl substituted derivatives thereof, and or mixtures of the compounds given. Most preferably the multiolefin crosslinking agent comprises divinylbenzene (DVB).

The amounts of particulate filler and multiolefin crosslinking agent in the modified filler should be sufficient to provide a composite in particulate form. Suitable relative amounts may be easily determined by simple experimentation. Suitable relative amounts may be dependent, in part, on the particle size of the particulate filler. Preferably, the crosslinking agent and particulate filler are present in the modified filler in a weight ratio of from 0.1 to 9 parts crosslinking agent for every 10 parts particulate filler, although more crosslinking agent may be possible. More preferably, the weight ratio is from 1 to 7 parts crosslinking agent for every 10 parts particulate filler, even more preferably from 2 to 7 parts crosslinking agent for every 10 parts particulate filler, and most preferably from 3 to 5 parts crosslinking agent for every 10 parts particulate filler.

The modified filler may be prepared by mixing particulate filler with multiolefin crosslinking agent to form a particulate composite of the particulate filler and the crosslinking agent. Mixing of the particulate filler and the crosslinking agent may be carried out with or without the presence of a solvent. When the crosslinking agent is a liquid, mixing is preferably carried out without a solvent. When the crosslinking agent is a solid, mixing may be carried out in a solvent, which is evaporated off after the mixing is complete. Solvents, when used, are preferably readily volatile organic solvents, for example, acetone. Preferably, the mulitolefin crosslinking agent is a liquid and no solvent is used in the mixing. Any suitable mixing technique may be used. For example, rotary mixers, ball rollers, paddle mixers, propeller mixers, etc. The choice of mixing technique will depend on the nature of the crosslinking agent and whether or not a solvent is used.

Polymer:

As indicated above, the one or more polymers in the rubber composition of the present invention have repeating units derived from one or more isoolefin monomers and repeating units derived from one or more multiolefin monomers.

The invention is not limited to a special isoolefin. However, isoolefins having from 4 to 16 carbon atoms, in particular 4-7 carbon atoms, such as isobutene, 2-methyl-1-butene, 3-methyl-1-butene, 2-methyl-2-butene, 4-methyl-1-pentene and mixtures thereof are preferred. Most preferred is isobutene.

The invention is not limited to a special multiolefin. Every multiolefin copolymerizable with the isoolefin known by the skilled in the art can be used. However, multiolefins having from 4-14 carbon atoms, such as isoprene, butadiene, 2-methylbutadiene, 2,4-dimethylbutadiene, piperylene, 3-methyl-1,3-pentadiene, 2,4-hexadiene, 2 -neopentylbutadiene, 2-methyl-1,5-hexadiene, 2,5-dimethyl-2,4-hexadiene, 2-methyl-1,4-pentadiene, 2-methyl-1,6-heptadiene, cyclopentadiene, methylcyclopentadiene, cyclohexadiene, 1-vinyl-cyclohexadiene and mixtures thereof, in particular conjugated dienes, are preferably used. Isoprene is particularly preferred. The multiolefin content is preferably greater than 4.1 mol %, more preferably greater than 5.0 mol %, even more preferably greater than 6.0 mol %, yet even more preferably greater than 7.0 mol %.

Optionally, repeating units derived from one or more other monomers may be included. As optional monomers every monomer copolymerizable with the isoolefins and/or dienes known by one skilled in the art can be used. Some representative examples are β-pinene, α-methyl styrene, p-methyl styrene, chlorostyrene, cyclopentadiene and methylcyclopentadiene.

The weight average molecular weight, M_{w}, of the polymer is preferably greater than 240 kg/mol, more preferably greater than 300 kg/mol, even more preferably greater than 500 kg/mol, yet even more preferably greater than 600 kg/mol. The gel content of the polymer is preferably less than 15 wt %, more preferably less than 10 wt %, even more preferably less than 5 wt %, yet even more preferably less than 3 wt %. The Mooney viscosity of the polymer is preferably 25 Mooney-units or greater, as determined using ASTM test D1646 using a large rotor at 125° C., a preheat phase of 1 min, and an analysis phase of 8 min (ML+8@125° C.).

Polymers are preferably prepared in a continuous polymerization process in slurry (suspension), in a suitable diluent, such as chloroalkanes as described in U.S. Pat. No. 5,417,930, the disclosure of which is herein incorporated by reference.

Preferably, the monomer mixture to be polymerized comprises from 80% to 95% by weight of one or more isoolefin monomers and from 4.0% to 20% by weight of one or more multiolefin monomers. More preferably, the monomer mixture comprises from 83% to 94% by weight of one or more isoolefin monomers and from 5.0% to 17% by weight of one or more multiolefin monomers. Most preferably, the monomer mixture comprises from 85% to 93% by weight of one or more isoolefin monomers and from 6.0% to 15% by weight of one or more multiolefin monomers.

The monomers are generally polymerized cationically, preferably at temperatures in the range from −120° C. to +20° C., preferably in the range from −100° C. to −20° C., and pressures in the range from 0.1 to 4 bar. Preferably, the process is conducted in one or more continuous reactors having a volume of between 0.1 m³ and 100 m³, more preferably between 1 m³ and 10 m³. Inert solvents or diluents known to the person skilled in the art for such polymerization reactions may be considered as the solvents or diluents (reaction medium). These comprise alkanes, chloroalkanes, cycloalkanes or aromatics, which are frequently also mono- or polysubstituted with halogens. Hexane/chloroalkane mixtures, methyl chloride, dichloromethane or the mixtures thereof may be mentioned in particular. Chloroalkanes are preferably used in the process according to the present invention.

The polymers comprising repeating units derived from one or more isoolefin monomers and one or more multiolefin monomers, as well as optionally further copolymerizable monomers, may be partially or fully chlorinated or brominated. Bromination or chlorination can be performed according to the procedures described in Rubber Technology, 3^{rd} Ed., Edited by Maurice Morton, Kluwer Academic Publishers, pp. 297-300 and references cited within this reference.

Rubber Composition:

Suitable amounts of polymer and modified filler in the rubber composition may be readily determined for any particular application by simple experimentation. Preferably, the amount of modified filler in the composition is in a range of from 25 to 90 phr (=per hundred rubber) by weight, more preferably from 50 to 85 phr, even more preferably from 65 to 80 phr.

Rubber compositions of the present invention are peroxide curable. The invention is not limited to any special peroxide curing system. For example, inorganic or organic peroxides are suitable. Preferred are organic peroxides such as dialkylperoxides, ketalperoxides, aralkylperoxides, peroxide ethers, peroxide esters, such as di-tert.-butyl peroxide, bis-(tert.-butyl peroxyisopropyl)-benzol, dicumyl peroxide, 2,5-dimethyl-2,5-di(tert.-butyl peroxy)-hexane, 2,5-dimethyl-2,5-di(tert.-butylperoxy)-hexene-(3), 1,1-bis-(tert.-butyl peroxy)-3,3,5-trimethyl-cyclohexane, benzoylperoxide, tert.-butylcumylperoxide and tert.-butylperbenzoate. Dicumylperoxide is particularly preferred.

Usually the amount of peroxide in the composition is in a range of from 1 to 10 phr by weight, preferably from 1 to 5 phr, more preferably from 2 to 4 phr. Subsequent curing is usually performed at a temperature in the range of from 100 to 200° C., preferably 130 to 180° C. Peroxides might be applied advantageously in a polymer-bound form. Suitable systems are commercially available, such as Polydispersion T(VC) D-40 P from Rhein Chemie Rheinau GmbH, D (=polymerbound di-tert.-butyl peroxy-isopropylbenzene).

Even if it is not preferred, the composition may further comprise other natural or synthetic rubbers such as BR (polybutadiene), ABR (butadiene/acrylic acid-C₁-C₄-alkylester-copolymers), CR (polychloroprene), IR (polyisoprene), SBR (styrene/butadiene-copolymers) with styrene contents in the range of 1 to 60 wt %, NBR (butadiene/acrylonitrile-copolymers with acrylonitrile contents of 5 to 60 wt %, HNBR (partially or totally hydrogenated NBR-rubber), EPDM (ethylene/propylene/diene-copolymers), FKM (fluoropolymers or fluororubbers), and mixtures thereof.

The rubber composition according to the invention can contain further auxiliary products for rubbers, for example reaction accelerators, vulcanizing accelerators, vulcanizing acceleration auxiliaries, antioxidants, foaming agents, anti-aging agents, heat stabilizers, light stabilizers, ozone stabilizers, processing aids, plasticizers, tackifiers, blowing agents, dyestuffs, pigments, waxes, extenders, organic acids, inhibitors, metal oxides, other fillers, and activators such as triethanolamine, polyethylene glycol, hexanetriol, etc., which are known to the rubber industry. The rubber aids are used in conventional amounts, which depend inter alia on the intended use. Conventional amounts are e.g. from 0.1 to 50 wt %, based on rubber. Preferably the composition further comprises in the range of from 0.1 to 20 phr by weight of an organic fatty acid, preferably a unsaturated fatty acid having one, two or more carbon double bonds in the molecule which more preferably includes 10% by weight or more of a conjugated diene acid having at least one conjugated carbon-carbon double bond in its molecule. Preferably those fatty acids have in the range of from 8-22 carbon atoms, more preferably 12-18. Examples include stearic acid, palmic acid and oleic acid and their calcium-, zinc-, magnesium-, potassium- and ammonium salts.

The rubber composition is prepared by mixing together the polymer, the modified filler and any further auxiliary products to form a mixture, and then curing the mixture with a peroxide. Curing is suitably performed at an elevated temperature that may range from 25° C. to 200° C. Normally the mixing time does not exceed one hour and a time in the range from 2 to 30 minutes is usually adequate. The mixing is suitably carried out in an internal mixer such as a Banbury mixer, or a Haake or Brabender miniature internal mixer. A two-roll mill mixer also provides a good dispersion of the additives within the polymer. An extruder also provides good mixing, and permits shorter mixing times. It is possible to carry out the mixing in two or more stages. The mixing can be done in different apparatuses, for example one stage in an internal mixer and one stage in an extruder. However, it should be taken care that no unwanted pre-crosslinking (=scorch) occurs during the mixing stage.

For further information concerning compounding (mixing) and vulcanization (curing) it is referred to Encyclopedia of Polymer Science and Engineering, Vol. 4, S. 66 et seq. (Compounding) and Vol. 17, S. 666 et seq. (Vulcanization), the disclosure of which is herein incorporated by reference.

Rubber compositions of the present invention are useful in forming shaped articles for a variety of applications, particularly in applications requiring rubbers that are cleaner and that have good sealing properties. The shaped articles may be cured or uncured, preferably cured. Being peroxide curable, cured rubber compositions of the present invention contain fewer extractable inorganic impurities (e.g. sulfur). Being based on polymers having repeating units derived from one or more isoolefin monomers and repeating units derived from one or more multiolefin monomers, rubber compositions of the present invention are also good in sealing applications as such compositions are non-permeable to gases such as oxygen, nitrogen, etc. and to moisture, and are stable towards acids, alkalis and other chemicals. Some specific non-limiting examples of applications are for condenser caps, biomedical devices, pharmaceutical devices (e.g. stoppers in medicine-containing vials, plungers in syringes, etc.), and seals for fuel cells. Application for condenser caps, particularly electrolytic condenser caps, may be particularly noted.

The rubber compositions of the present invention are particularly advantageous as they have superior hardness and ultimate elongation properties while, at the same time, have similar or superior ultimate tensile properties, in comparison to prior art compositions.

### BRIEF DESCRIPTION OF THE DRAWING

In order that the invention may be more clearly understood, preferred embodiments thereof will now be described in detail by way of example, with reference to the accompanying drawing, in which:

FIG. 1 depicts MDR cure curves for Examples 3, 6 and 7.

### EXAMPLES

Materials and Equipment:

| | |
|---|---|
| carbon black (CB) | IRB #7 |
| divinylbenzene (DVB) | (ca. 63.5%, Dow Chemical) |
| dicumylperoxide | (DI-CUP 40C, Struktol Canada |
| | Ltd.) |

Mixing of a rubber compositions was accomplished with the use of a miniature internal mixer (Brabender MIM) from C. W. Brabender, consisting of a drive unit (Plasticorder® Type PL-V151) and a data interface module.

Curing was achieved with the use of an Electric Press equipped with an Allan-Bradley Programmable Controller. Cure characteristics were determined with a Moving Die Rheometer (MDR) test carried out according to ASTM standard D-5289 on a Monsanto MDR 200 (E). The upper disc oscillated though a small arc of 1 degree. Stress-strain tests were carried out using an Instron Testmaster Automation System, Model 4464.

Processes:

In the examples, composites of carbon black and divinylbenzene (DVB) were prepared by placing a given amount of carbon black in a 100 ml amber wide-mouth glass jar followed by addition of a given volume of the DVB over the whole area of carbon black. Five ceramic balls (1 cm diameter) were added into the jar. The lid was put on the jar and secured with vinyl electrical tape. The jar was rolled on a rolling machine for a period of 1 hour.

Mixing of the rubber compositions in the examples was achieved with the use of a Brabender internal mixer (capacity ca. 75 g) with a starting temperature of 23° C. and a mixing speed of 50 rpm according to the following sequence:
0.0 min: polymer added
1.5 min: carbon black or composite (CB+DVB) added
7.0 min: peroxide added
8.0 min: mix removed
   The final composition was refined on a 6″×12″ mill.

### Example 1

### Comparative

The composition of Example 1 was based on a commercial butyl rubber (Bayer Butyl 402, isobutylene content=97.8 mol %, isoprene content=2.2 mol %). No DVB was added in this case to the Brabender mixer.

The butyl rubber (100 parts), carbon black (50 parts) and dicumylperoxide (3 parts) were mixed in the manner described above. As expected, no evidence of cure could be seen during the MDR test.

### Example 2

### Comparative

The composition of Example 2 was based on a high isoprene butyl rubber (high IP IIR) prepared in the commercial facility of Bayer Inc. in Sarnia, Canada. The rubber had an isoprene content of 7.5 mol %. This experimental high isoprene IIR elastomer contained trace amounts of DVB (ca. 0.07-0.11 mol %) from its manufacturing process.

This level of DVB is less than 10% of that found in commercial XL-10000 (ca. 1.2-1.3 mol %). The gel content of this rubber was less than 5 wt %. No DVB was added in this case to the Brabender mixer.

The high isoprene butyl rubber (100 parts), carbon black (50 parts) and dicumylperoxide (4 parts) were mixed in the manner described above. The cured composition gave the following test results: delta torque=2.15 dNem, Shore A hardness=30 points, ultimate tensile=4.70 MPa, and ultimate elongation=998%. This demonstrated that the high isoprene butyl rubber was more suitable for peroxide cure than the conventional butyl rubber.

### Example 3

### Comparative

The composition of Example 3 was based on a commercial rubber (Bayer XL-10000). No DVB was added in this case to the Brabender mixer. The rubber (100 parts), carbon black (50 parts) and dicumylperoxide (2 parts) were mixed and vulcanized. The cured composition gave the following test results: Δ torque=11.45 dN·m, Shore A hardness=57 points, ultimate tensile=4.86 MPa, and ultimate elongation=126%.

### Example 4

### Comparative

A composite of 10 g of carbon black (IRB#7) and 7 g of DVB was prepared according to the mixing procedure described above. This resulted in a dry free-flowing powdery product. This indicated that 100 weight parts of carbon black IRB#7 could combine with at least 70 weight parts of liquid divinylbenzene in forming a desirable dry powdery composite of the two ingredients.

### Example 5

### Comparative

A composite of 10 g of carbon black (IRB#7) and 10 g of DVB was prepared according to the mixing procedure described above. This resulted in a wet paste stuck around the ceramic balls present in the glass jar. This indicated that the weight ratio 1:1 of carbon black IRB#7 and liquid divinylbenzene was not suitable for obtaining a dry powdery composite of the two ingredients.

### Example 6

### Invention

The composition of Example 6 was based on the high isoprene butyl rubber (high IP IIR) described in Example 2.

The high isoprene rubber (100 parts), 65 parts of a free-flowing composite of carbon black and DVB (23 g CB+4.6 g DVB), and 2 parts of dicumylperoxide were mixed and vulcanized. The cured composition gave the following test results: Δ torque=14.99 dN·m, Shore A hardness=58 points, ultimate tensile=5.38 MPa, and ultimate elongation=386%. These results were better than those given in Example 3 for a condenser cap application.

### Example 7

### Invention

The composition of Example 7 was based on the high isoprene butyl rubber (high IP IIR) described in Example 2.

The high isoprene rubber (100 parts), 80 parts of a free-flowing composite of carbon black and DVB (23 g CB+6.9 g DVB), and 2 parts of dicumylperoxide were mixed and vulcanized. The cured composition gave the following test results: A torque=45.21 dN·m, Shore A hardness=74 points, ultimate tensile=5.59 MPa, and ultimate elongation=288%. These results demonstrated that using the present method it was possible to obtain a composition having a value of Shore A hardness above 70 points while the ultimate elongation was above 200%. At the same time, the ultimate tensile was similar or better than that for a reference composition based on XL-10000 (Example 3). No direct handling of a liquid DVB in an internal mixer was involved.

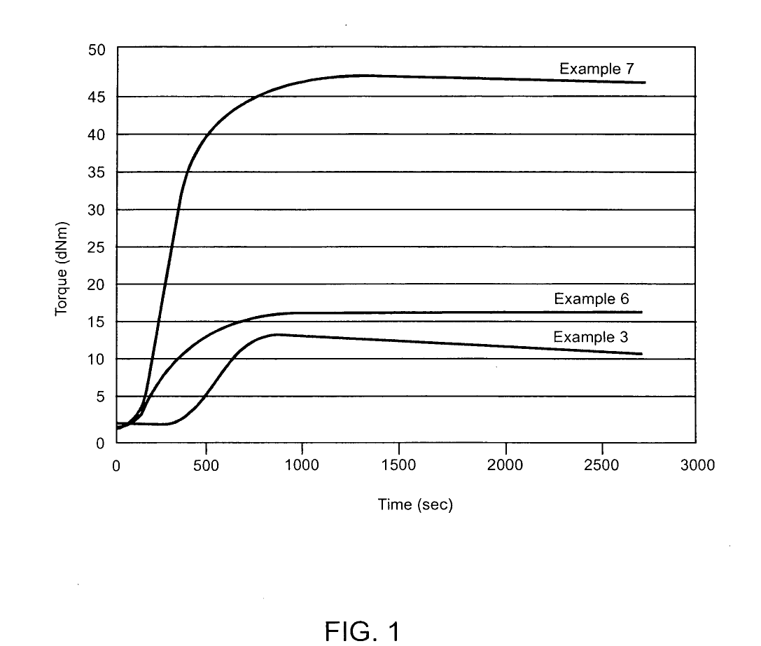

The results for Examples 3, 6 and 7 are summarized in Table 1 and the MDR curves of the compositions are given in FIG. 1.

TABLE 1

| | System | | |
|---|---|---|---|
| | | Example 6 | Example 7 |
| | Example 3 | high IP IIR + | high IP IIR + |
| Property | XL-10000 | (CB + DVB) | (CB + DVB) |
| Hardness, Shore A (pts.) | 57 | 58 | 74 |
| Ultimate Elongation (%) | 126 | 386 | 288 |
| Ultimate Tensile (MPa) | 4.86 | 5.38 | 5.59 |
| Δ Torque (dN · m) | 11.45 | 14.99 | 45.21 |

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features and sub-combinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

What is claimed is:

1. A peroxide curable rubber composition comprising: one or more polymers having repeating units derived from one or more isoolefin monomers and repeating units derived from one or more multiolefin monomers; and, a modified filler comprising a particulate composite of a particulate filler and a multiolefin crosslinking agent.

2. The composition of claim 1, wherein the particulate filler is carbon black.

3. The composition of claim 1, wherein the multiolefin crosslinking agent is divinylbenzene.

4. The composition of any one of claim 1, wherein the multiolefin crosslinking agent and the particulate filler are present in the modified filler in a weight ratio of 0.1 to 9 parts crosslinking agent for every 10 parts particulate filler.

5. The composition of any one of claim 1, wherein the isoolefin monomer is isobutene.

6. The composition of any one of claim 1, wherein the multiolefin monomer is isoprene.

7. The composition of any one of claim 1, wherein the multiolefin is present in the one or more polymers in an amount greater than 4.1 mol %.

8. The composition of any one of claim 1, further comprising one or more peroxides.

9. A process for preparing a cured rubber composition comprising: mixing a polymer having repeating units derived from one or more isoolefin monomers and repeating units derived from one or more multiolefin monomers with a modified filler comprising a particulate composite of a particulate filler and a multiolefin crosslinking agent to form a mixture; and, curing the mixture with one or more peroxides.

10. A shaped article comprising a rubber composition according to claim 1.

11. The article of claim 10 in the form of a condenser cap.

12. A modified filler comprising a particulate composite of a particulate filler and a multiolefin crosslinking agent.

13. The modified filler of claim 12, wherein the particulate filler is carbon black.

14. The modified filler of claim 12, wherein the multiolefin crosslinking agent is divinylbenzene.

15. The composition of claim 12, wherein the multiolefin crosslinking agent and the particulate filler are present in the modified filler in a weight ratio of 0.1 to 9 parts crosslinking agent for every 10 parts particulate filler.
